(19) United States
(12) Patent Application Publication
(10) Pub. No.: US 2014/0222515 A1
(43) Pub. Date: Aug. 7, 2014

(54) SYSTEMS AND METHODS FOR ENHANCED PRINCIPAL COMPONENTS ANALYSIS

(71) Applicant: Pitney Bowes Inc., Danbury, CT (US)

(72) Inventor: Robert A. Cordery, Monroe, CT (US)

(73) Assignee: Pitney Bowes Inc., Danbury, CT (US)

(21) Appl. No.: 14/132,991

(22) Filed: Dec. 18, 2013

Related U.S. Application Data
(60) Provisional application No. 61/747,462, filed on Dec. 31, 2012.

(51) Int. Cl. G06Q 30/02

(52) U.S. Cl. CPC G06Q 30/0205
USPC 705/7.34

(57) ABSTRACT

Systems and methods for providing geodemographic analyses using a unique weighting, centering and scaling approach for intensive variables is provided in a principal components analysis. The system may use an extensive variable as a size parameter that is appropriate for the particular geodemographic application. Additionally, a sizing function may be applied to the determined principal components before a clustering analysis.

### TECHNICAL FIELD

The illustrative embodiments of the present invention relate generally to geodemographic analysis systems and, more particularly, to new and useful systems and methods for providing geodemographic analyses using a unique weighted, scaled and centered principal components analysis.

### BACKGROUND

Targeted marketing is generally considered an important part of a business marketing effort and entails trying to focus advertising on those who are more likely to purchase a product.

A popular business to consumer (B2C) targeting marketing tool is the PSYTE HD geodemographic segmentation tool available from Pitney Bowes Software, Inc. of Troy, N.Y., that uses “psychographic” indicators for consumers to provide a relatively accurate “snapshot” of American neighborhoods. Additionally, B2B marketing segmentation tools exist such as the D&B Business Segmentation product available from D&B of Short Hills, N.J. The D&B SEGMENTER provide business segmentation using existing D&B data points such as the size of the business, the applicable Standard Industrial Classification (SIC) code and a risk score that D&B assigns to the business. Other targeted marketing segmentation products and or related data are available from Infogroup of Papillion, Nebr. and Experian of Costa Mesa, Calif. Some systems allow segmentation by demographic-like data points including a number of employees and/or a number of locations. Additionally, some systems use the six-digit North American Industry Classification System (NAICS) code instead of SIC codes.

### SUMMARY

Illustrative system and methods for providing geodemographic analyses using a unique weighted, scaled and centered principal components analysis are described.

In certain embodiments, the system may use an extensive variable as a size parameter that is appropriate for the particular geodemographic application.

In certain additional embodiments, a sizing function may be applied to the determined principal components before a clustering analysis.

### BRIEF DESCRIPTION OF THE DRAWINGS

The accompanying drawings show illustrative embodiments of the invention and, together with the general description given above and the detailed description given below serve to explain certain principles of the invention. As shown throughout the drawings, like reference numerals designate like or corresponding parts.

FIG. 1 is a diagram showing a system and information flow for providing enhanced principal components analysis according to an illustrative embodiment of the present application.

FIG. 2 is a process flow diagram showing an enhanced principal components analysis according to an illustrative embodiment of the present application.

### DETAILED DESCRIPTION

The illustrative embodiments of the present invention described herein are often described in the context of a marketing segmentation tool operating on data from one or more databases. In certain embodiments, systems and methods for providing geodemographic analyses using a unique weighted, scaled and centered principal components analysis are described. In certain embodiments, the system may use an extensive variable as a size parameter that is appropriate for the particular geodemographic application. In certain additional embodiments, a sizing function may be applied to the determined principal components before a clustering analysis.

Several novel segmentation and clustering approaches are described. For example, several of the illustrative embodiments described herein use a unique centering and scaling method before performing a principal components analysis.

There are several statistical methods described herein that are described with reference to the programming language and libraries known as the R programming language available from The R Foundation for Statistical Computing of Vienna, Austria. Additional statistical systems may be used as appropriate such as the IBM SPSS system, available from IBM Corp. of Armonk, N.Y. In certain illustrative embodiments, the systems and methods described are created by modifying the source code of the R programming language functions such as prcomp.

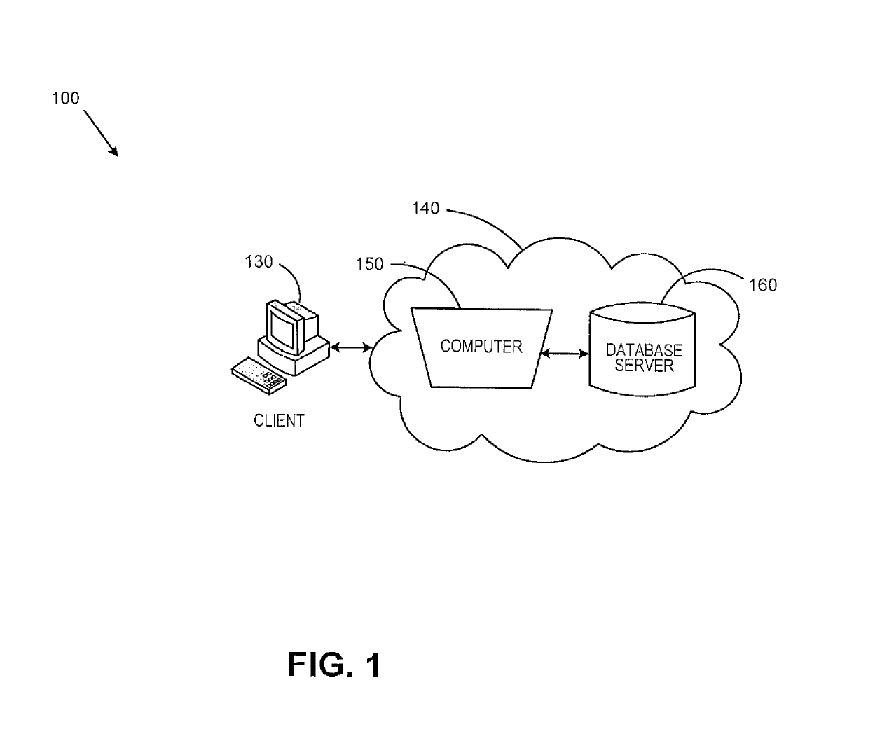

Referring to FIG. 1, a diagram showing a system 100 and information flow for providing enhanced principal components analysis according to an illustrative embodiment of the present application is provided. The illustrative processes described herein may be performed on generic data to obtain one or more generic market segmentations. Similarly, generic vertical market data may be utilized to achieve vertical market segmentations that are not specific to any seller in that vertical. However, the process may also take seller specific data as an input to customize the output market segmentation for a particular seller.

A typical Client is represented by Client terminal 130. This client may access a generic market segmentation or may engage the system for a customized segmentation. If the system 100 is configured in a Software as a Service (SaaS) model, the client terminal 130 may be a personal computer using a web browser to access the system 140 in a cloud through an internet connection. In an on premise solution, the system 140 and associated systems may be located on a server behind the client firewall. In such a case, client terminal may utilize a heavy client or alternatively a web browser to access that server using a local area network (LAN). In another model, the client terminal 130 may run a customized application that interfaces with the custom segmentation system using an Application Program Interface (API).

The segmentation processing system is shown in cloud 140 in this illustrative embodiment. The analysis engine 150 executes the code to run the processes described herein and may run as a cloud process in a virtual machine or may instead run on a dedicated server such as a DELL XEON based server running WINDOWS ENTERPRISE 7. The database server 160 may be a cloud data instance, may be a standalone database or may be included on the same server that hosts the analysis engine. In an illustrative example, the database server 160 is SQL SERVER 2012. Several external databases may be accesses in real time or prior to execution of the processes running on the analysis engine 150. For example, the external data sources may be accessed using one or more of SOAP/REST web services, custom APIs or even data transfer in XML or other data format using file transfer protocol FTP, email, HTML or even physical media transfer into a file or database on the database server 160. Database server includes access to third party databases such as one or more other public/government databases such as those that provide economic indicators by geography such as employment numbers and unemployment numbers. Similarly, United States government census data is available. The Database server 160 has access to foreclosure data such as that available from commercial firm REALTYTRAC of Irvine, Calif. Similarly, database server 160 has access to a variety of data that is available from D&B and additional third parties.

In geodemographic analysis a geographical area is typically divided into smaller regions and data characterizing each region are collected from a variety of sources. Some “extensive” variables, such as population are additive. When regions are combined, the value of an extensive variable for the combined region is, at least approximately, the sum of the values for the individual regions. Other “intensive” variables, such as median age, do not add when regions are combined. The illustrative embodiments herein describe how extensive and intensive variables can be treated consistently in geodemographic analysis, especially in principal component analysis (PCA).

Extensive and Intensive Variables

Quantities used to characterize a region in geodemographic analysis can represent the amount of something such as population in the age range 50 to 60 or a quality such as median income. Positive “extensive” variables represent an amount, for example, total postage, number of businesses with more than 10 employees, or number of households with income over $100,000. When regions are combined, the value of these variables for the combined region is, at least approximately, the sum of the values for the individual regions. This additive property is the defining characteristic of extensive variables. Other “intensive” variables, such as average age, average number of people per household and average postage reset value do not add when regions are combined. In practice, the value of the intensive variable for the combined region is nearly always between the maximum and minimum values for the regions making up the combined region. (Exceptions can occur for intensive variables such as the mode of the distribution of ages.) The way to distinguish extensive and intensive variables is therefore to consider what happens to the value when regions are combined or divided.

The regions used in geodemographic analysis vary in size, sometimes substantially. The division into regions is often somewhat arbitrary, guided by political divisions, postal codes, neighborhood characteristics, or other criteria. Extensive variables tend to be proportional to the size of the region. Intensive variables tend to be more-or less independent of the size of the region. When using both intensive and extensive variables in analysis, it is necessary to treat the size of the region correctly. In certain illustrative embodiments described herein, a guiding principle (GP) is that statistical conclusions for one region should not change (much) if other regions are divided or combined.

There are many definitions of size of a region. The selection depends partly on your purpose. Population, number of households, geographical area, total income, total business revenue, or number of businesses would all be appropriate size definitions for some application. Actually, any positive extensive variable would be a candidate for size. It is possible to use different definitions of size when considering different variables. For demographic data, population is a natural choice. For firmographic data, number of businesses or some other measure of the amount of business in an area is a better choice. For land use data, total area could be used.

If multiple size variables are used, then a set of their differences must be included as separate centered variables. For example suppose there are three scaled size variables used for centering: S_{rd} for population, S_{rf} for business and Sᵣₐ for land area. The set of centered variables need to be augmented by a complete linearly independent set of differences such as S_{rf}−S_{rd} and Sᵣₐ−S_{rd}. In general if there are N size variables then we must add N−1 differences of size variables to the list of variables used in PCA. These differences have a simple interpretation. As an example, the difference Sᵣₐ−S_{rd} represents the fraction of the land area in a region minus the fraction of the population, so it will be positive in regions with a lot of land per person and negative in high population density regions.

An intensive variable is roughly independent of the “size” of the region, i.e., they are proportional to size⁰. Extensive variables are roughly proportional to the size of a region, i.e., they are proportional to size¹. An intensive variable multiplied by an extensive variable is proportional to size¹, so it is an extensive variable. Similarly, the ratio of two extensive variables is intensive. The inverse of an intensive variable is intensive. Any function of a set of intensive variables is intensive. A linear combination for each region of a set of extensive variables is extensive, although it may be negative. Combining extensive variables from different regions may lose the extensive nature of the variable. In particular, the total of an extensive variable over all regions should be considered as a number, not as an extensive variable, because it does not change when the area is analyzed at a coarser or finer scale.

How do you treat intensive variables when combining regions? A choice described more fully herein is to perform a weighted average of an intensive variable over the regions, weighting each region's contribution by the appropriate “size” of that region and then dividing the sum by the total size. Weighting the intensive variable by size converts it to an extensive variable.

Intensive variables are representative of some characteristic of a region while extensive variables represent the amount of some quantity. It does not generally make much sense to add extensive and intensive variables. Principal component analyses that produce linear combinations of intensive and extensive variables are suspect. Dividing up the area differently will produce different results. In the following, intensive variables will be converted to extensive variables by multiplying by a weighting factor.

There are quantities that do not scale independently or linearly with the “size” of the region. For example, number of possible person-business pairs is the product of two extensive variables and so is proportional to the square of the size of the region. These types of variables should be used very carefully. For example the number of unique visitors to stores does not likely scale like the product of the number of stores and the number of people.

Applying principal component analysis (PCA) requires scaling variables so that they are comparable and zeroing their average. Scaling and zeroing should be done so as to be consistent with our GP.

Scaling and Centering Positive Extensive Variables

How should we scale extensive variables when regions are different sizes? The standard method of scaling variables for principal components is to normalize the variance to unity. However, we have found that this is inconsistent with our GP. A more meaningful scaling consistent with our GP for a non-negative extensive variable is to scale so that the sum of the scaled variable over all regions is unity. This has the advantage that if a region is split or two regions combined, the scaled variable does not change in other regions. This scaled extensive variable is the fraction of the total of the original extensive variable in each region. All else being equal, it should be approximately the same as the scaled region size.

How should we center, i.e., zero the average of, a positive extensive variable? The standard method of zeroing is to subtract the average of the variable over regions from each region. While this results in zero average, it does not treat large and small regions correctly or consistent with our GP. A better approach used here is to calculate the total of the extensive variable over regions (which is 1 for a scaled variable). For each region subtract that total times the fraction of the appropriate “size” in that region. If the size and the extensive variable have been scaled as above, then the zeroed scaled variable is simply the difference between the scaled positive extensive variable and the scaled size. It represents the amount that the value of the extensive variable for each region exceeds (or fails to reach if negative) the value expected given the size of the region. For an area of N regions, the scaled, centered version of a positive extensive variable eV in region r using a size variable S is shown in Eq. 1 below:

$${v}_{r} = \frac{e {V}_{r}}{{\sum }_{q = 1}^{N} e {V}_{q}} - \frac{{S}_{r}}{{\sum }_{q = 1}^{N} {S}_{q}} . \qquad ( Eq . 1 )$$

This variable can be very small, and will not contribute much to the principal components, if the positive extensive variable is accurately proportional to the chosen size variable. The denominators here are viewed as scale factors (as stated above, they are just a number, independent of the region).

Non-Positive Extensive Variables

Extensive variables that are not “amounts” or are not positive arise in various ways. One common source is a variable representing change in a positive extensive variable over a time period. In that case, the values of the positive extensive variable should be scaled and centered as above, and then the change calculated. A non-positive extensive variable can be centered by subtracting the total times a size variable. Scaling consistently is more ambiguous. Sometimes, variables that represent an amount may not be strictly positive. For example, net corporate profit is an amount, but in some regions may be negative. Hopefully, the total over regions is not negative! In case the total is more-or-less guaranteed to be positive and the values in regions are usually positive, the variable can be treated the same as a positive extensive variable. Otherwise, a reasonable choice is to scale the centered variable so that the variance is the same as the variance of other variables.

Intensive Variables

Intensive variables should be weighted by the appropriate “size” and then treated as extensive variables. In this way extensive and size-weighted intensive variables can be treated together in PCA. For an area of N regions, the scaled, centered version of an intensive variable iV using a size variable S is shown in Eq. 2 below:

$${v}_{r} = \frac{{iV}_{r} {S}_{r}}{{\sum }_{q = 1}^{N} {iV}_{q} {S}_{q}} - \frac{{S}_{r}}{{\sum }_{q = 1}^{N} {S}_{q}} . \qquad ( Eq . 2 )$$

Multiple Size Variables

If there are multiple size variables and multiple types of measured variables then, for clarity, the equations for extensive and intensive scaled centered variables need an index m for the measured variables and an index s(m) indicating which size variable to use for variable m.

For intensive variables the expression with all indices explicit for the variables to include in PCA is:

$${v}_{r , m} = \frac{{iV}_{r , m} {S}_{r}^{s ( m )}}{{\sum }_{q = 1}^{N} {iV}_{q , m} {S}_{q}^{s ( m )}} - \frac{{S}_{r}^{s ( m )}}{{\sum }_{q = 1}^{N} {S}_{q}^{s ( m )}} . \qquad ( Eq . 2 )$$

For extensive variables the expression with all indices explicit for the variables to include in PCA is:

$${v}_{r , m} = \frac{e {V}_{r , m}}{{\sum }_{q = 1}^{N} e {V}_{q , m}} - \frac{{S}_{r}^{s ( m )}}{{\sum }_{q = 1}^{N} {S}_{q}^{s ( m )}} . \qquad ( Eq . 2 )$$

It is necessary to include as variables in the PCA a set of additional centered variables that are differences between the size variables. If there are M size variables a suitable set of M−1 variables representing differences between size variables is {S^{m}−S¹|m=2 . . . . M}.

Looking for Clusters

How can a region be characterized using extensive variables and size-weighted intensive variables? After PCA, most of the variance is accounted for by approximating each region by its projections on the first few principal components. These weights or scores are extensive variables. Regions with the same characteristics but different sizes lie along a line going through the origin. This will make it difficult to perform clustering. The scores can be converted to intensive by dividing by a principal component size variable.

How can the size variable be defined for a principal component? The appropriate size variable may be different for different variables, but the principal component scores are a linear combination of variables. A reasonable solution is to divide the scores for each region by one size variable such as population of the region. While this should generally work, consider a problem where the appropriate size for some variables is the population while other variables are proportional to a firmographic size such as the number of businesses. If these sizes do not track well across regions, then some principal components may be more business related while others are more population related. An appropriate size variable is shown below in Eq. 3:

$${S}_{r , pc} = \frac{{\sum }_{m}^{ } {size}_{r , m} \vert {P}_{m , pc} \vert}{{\sum }_{{m}^{′}}^{ } {\vert {P}_{{m}^{′} , pc} \vert}^{2}} , \qquad ( Eq . 3 )$$

where here the principal components are in the columns of P and the size variable size is optionally allowed to depend on the measured variable m. A similar alternative size variable for the principal component pc is shown in Eq. 4.

$${S}_{r , pc} = \frac{{\sum }_{m}^{ } {size}_{r , m} \vert {P}_{m , pc} \vert}{{\sum }_{{m}^{′}}^{ } {\vert {P}_{{m}^{′} , pc} \vert}^{2}} . \qquad ( Eq . 4 )$$

Accordingly, in certain embodiments when performing PCA for geodemographic analysis, it is very helpful to maintain the extensive nature of all variables for consistent results. In analyzing clusters, the results of PCA may preferably be converted back to intensive variables.

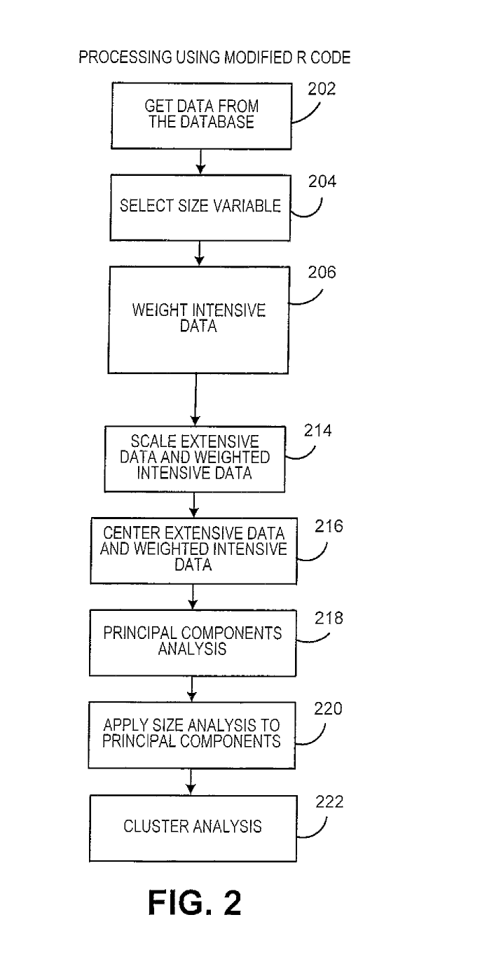

Referring to FIG. 2, a process flow diagram showing an enhanced principal components analysis according to an illustrative embodiment of the present application is provided.

In step 202, the system obtains data from the database such as 160. The database 160 may have already been populated with the relevant external data described above. Alternatively, the data is obtained on the fly as needed or otherwise. In one illustrative configuration, a set of about 350 variable from the datasets mentioned are utilized as described herein. One of skill in the art with the datasets can use a typical configuration, or even all available variables. In one example, a clustering effort directed at potential customers for postage meters might use a NAICS filter to obtain a group of 11 million SMBs for consideration across 350 initial variables—some intensive, some extensive. The datasets can further have each variable labeled as intensive or extensive for use herein.

In step 204, the system selects a size variable as discussed above. In one configuration, if geodemographic analysis is performed in a B2B context, the appropriate size variable selected is related to the amount of business done in an area, for example, total revenue.

In step 206, the intensive variable data for each intensive variable are weighted for each selected geographic division of data by the size variable from step 204.

In step 214, a custom scaling process is used as described above.

In step 216, a custom centering process is used as described above.

In step 218, the principal components analysis is performed.

In step 220, a sizing function is applied to the output principal components as described above.

In step 222, the clustering analysis is performed on the sized output principal components.

The various systems and subsystems described herein may alternatively reside on a different configuration of hardware such as a single server or distributed server such as providing load balancing and redundancy. Alternatively, the described systems may be developed using general purpose software development tools including Java and/or C++ development suites. The server systems described herein typically include WINDOWS/INTEL Servers such as a DELL POWEREDGE Server running WINDOWS SERVER and include database software including MICROSOFT SQL and/or ORACLE 10i software. Alternatively, other servers such a SUN FIRE T2000 and associated web server software such as SOLARIS and JAVA ENTERPRISE and JAVA SYSTEM SUITES may be obtained from several vendors including Sun Microsystems, Inc. of Santa Clara, Calif. PC. Alternative database systems such as SQL may be utilized.

The user computing systems described may include WINDOWS/INTEL architecture systems running WINDOWS and INTERNET EXPLORER BROWSER such as the DELL DIMENSION E520 available from Dell Computer Corporation of Round Rock, Tex. While the electronic communications networks have been described as physically secure local area network (LAN) connections in a facility, external or wider area connections such as secure Internet connections may be used. Other communications channels such as Wide Area Networks, telephony and wireless communications channels may be used. One or more or all of the data connections may be protected by cryptographic systems and/or processes.

Each computer described herein may include one or more operating systems, appropriate commercially available software, one or more displays, wireless and/or wired communications adapter(s) such as network adapters, nonvolatile storage such as magnetic or solid state storage, optical disks, volatile storage such as RAM memory, one or more processors, serial or other data interfaces and user input devices such as keyboard, mouse and audio/visual interfaces. Laptops, tablets, PDAs and smart phones may alternatively be used herein.

Although the invention has been described with respect to particular illustrative embodiments thereof, it will be understood by those skilled in the art that the foregoing and various other changes, omissions and deviations in the form and detail thereof may be made without departing from the scope of this invention.

What is claimed is:

1. A computer implemented method for performing a geodemographic principal components analysis on a combination of data from a plurality of geographic regions, whereby relative sizes of regions does not skew statistical conclusions, the method comprising:
obtaining, from a database, data corresponding to positive extensive variables for analysis, the data being associated with the plurality of geographic regions;
selecting one of the at least one positive extensive variables as a size parameter relevant for purposes of the analysis;
scaling, with a processor, data for the positive extensive variables to create scaled positive extensive variables, wherein said scaling is done by dividing individual positive extensive variables by a total of positive extensive variables over all regions;
centering, with the processor, data for the positive extensive variables, wherein said centering is done in proportion to the size of the region's size parameter relative to the total size of all regions; and
performing a principal components analysis of the scaled and centered data.

2. The method of claim 1 further comprising:
obtaining, from the database, data corresponding to at least one intensive variable;
weighting each of the at least one intensive variables and corresponding data using the size parameter;
scaling, with the processor, data for the weighted intensive variables to create scaled weighted intensive variables by dividing individual weighted intensive variables by a total of weighted intensive variables over all regions; and
centering, with the processor, data for the weighted intensive variables, wherein said centering is done in proportion to the size of the region's size parameter relative to the total size of all regions.

3. The method of claims 1, further comprising:
performing a sizing function on principal components determined by the principal components analysis.

4. The method of claim 3, further comprising:
performing a cluster analysis on the sized principal components.

5. The method of claim 1, wherein,
selecting one of the at least one positive extensive variables as a size parameter is done based upon an application type.

6. The method of claim 5, wherein,
the application type is firmographic and the at least one positive extensive variable selected as a size parameter relates to the amount of business in an area.

7. The method of claim 1, wherein,
scaling and centering of data for the positive extensive variables is performed using the equation:
$${v}_{r} = \frac{e {V}_{r}}{{\sum }_{q = 1}^{N} e {V}_{q}} - \frac{{S}_{r}}{{\sum }_{q = 1}^{N} {S}_{q}} .$$

8. The method of claim 2, wherein,
scaling and centering of data for the weighted intensive variables is performed using the equation:
$${v}_{r} = \frac{{iV}_{r} {S}_{r}}{{\sum }_{q = 1}^{N} {iV}_{q} {S}_{q}} - \frac{{S}_{r}}{{\sum }_{q = 1}^{N} {S}_{q}} .$$

9. The method of claim 3, wherein,
performing a sizing function on the principal components is performed using the equation:
$${S}_{r , pc} = \frac{{\sum }_{c}^{ } {size}_{r , c} \vert {P}_{c , pc} \vert}{{\sum }_{c}^{ } \vert {P}_{c , pc} \vert} .$$

10. The method of claim 1, wherein there are multiple size variables and multiple types of measured variables and scaling and centering of data for the positive extensive variables is performed using the equation:
$${v}_{r , m} = \frac{e {V}_{r , m}}{{\sum }_{q = 1}^{N} e {V}_{q , m}} - \frac{{S}_{r}^{s ( m )}}{{\sum }_{q = 1}^{N} {S}_{q}^{s ( m )}} .$$

11. The method of claim 2, wherein there are multiple size variables and multiple types of measured variables and scaling and centering of data for the weighted intensive variables is performed using the equation:
$${v}_{r , m} = \frac{{iV}_{r , m} {S}_{r}^{s ( m )}}{{\sum }_{q = 1}^{N} {iV}_{q , m} {S}_{q}^{s ( m )}} - \frac{{S}_{r}^{s ( m )}}{{\sum }_{q = 1}^{N} {S}_{q}^{s ( m )}} .$$

12. A computer system comprising a processor and one or more data storage devices including a database, the processor configured to perform a geodemographic principal components analysis on a combination of data in the one or more data storage devices from a plurality of geographic regions, whereby relative sizes of regions does not skew statistical conclusions, the processor further configured to perform the following steps in the analysis:
obtaining, from the database, data corresponding to positive extensive variables for analysis, the data being associated with the plurality of geographic regions;
identifying one of the at least one positive extensive variables as a size parameter relevant for purposes of the analysis;
scaling, with the processor, data for the positive extensive variables to create scaled positive extensive variables, wherein said scaling is done by dividing individual positive extensive variables by a total of positive extensive variables over all regions;
centering, with the processor, data for the positive extensive variables, wherein said centering is done in proportion to the size of the region's size parameter relative to the total size of all regions; and
performing a principal components analysis of the scaled and centered data.

13. The computer system of claim 12 wherein the processor is further configured to perform the steps of:
obtaining, from the database, data corresponding to at least one intensive variable;
weighting each of the at least one intensive variables and corresponding data using the size parameter;
scaling, with the processor, data for the weighted intensive variables to create scaled weighted intensive variables by dividing individual weighted intensive variables by a total of weighted intensive variables over all regions; and
centering, with the processor, data for the weighted intensive variables, wherein said centering is done in proportion to the size of the region's size parameter relative to the total size of all regions.

14. The computer system of claim 12 wherein the processor is further configured to perform the steps of:
performing a sizing function on principal components determined by the principal components analysis.

15. The computer system of claim 14 wherein the processor is further configured to perform the steps of:
performing a cluster analysis on the sized principal components.

16. The computer system of claim 12 wherein:
selecting one of the at least one positive extensive variables as a size parameter is done based upon an application type.

17. The computer system of claim 16 wherein,
the application type is firmographic and the at least one positive extensive variable selected as a size parameter relates to the amount of business in an area.

18. The computer system of claim 12 wherein,
scaling and centering of data for the positive extensive variables is performed using the equation:
$${v}_{r} = \frac{e {V}_{r}}{{\sum }_{q = 1}^{N} e {V}_{q}} - \frac{{S}_{r}}{{\sum }_{q = 1}^{N} {S}_{q}} .$$

19. The computer system of claim 13 wherein,
scaling and centering of data for the weighted intensive variables is performed using the equation:
$${v}_{r} = \frac{{iV}_{r} {S}_{r}}{{\sum }_{q = 1}^{N} {iV}_{q} {S}_{q}} - \frac{{S}_{r}}{{\sum }_{q = 1}^{N} {S}_{q}} .$$

20. The computer system of claim 12 wherein,
performing a sizing function on the principal components is performed using the equation:
$${S}_{r , pc} = \frac{{\sum }_{c}^{ } {size}_{r , c} \vert {P}_{c , pc} \vert}{{\sum }_{c}^{ } \vert {P}_{c , pc} \vert} .$$

21. The computer system of claim 12, wherein there are multiple size variables and multiple types of measured variables and scaling and centering of data for the positive extensive variables is performed using the equation:
$${v}_{r , m} = \frac{e {V}_{r , m}}{{\sum }_{q = 1}^{N} e {V}_{q , m}} - \frac{{S}_{r}^{s ( m )}}{{\sum }_{q = 1}^{N} {S}_{q}^{s ( m )}} .$$

22. The computer system of claim 13 wherein there are multiple size variables and multiple types of measured variables and scaling and centering of data for the weighted intensive variables is performed using the equation:
$${v}_{r , m} = \frac{{iV}_{r , m} {S}_{r}^{s ( m )}}{{\sum }_{q = 1}^{N} {iV}_{q , m} {S}_{q}^{s ( m )}} - \frac{{S}_{r}^{s ( m )}}{{\sum }_{q = 1}^{N} {S}_{q}^{s ( m )}} .$$
